(19) United States
(12) Patent Application Publication
(10) Pub. No.: US 2012/0156527 A1
(43) Pub. Date: Jun. 21, 2012

(54) ASSEMBLED BATTERY MODULE

(75) Inventor: Shuji Kataoka, Sagamihara-shi (JP)

(73) Assignee: NEC ENERGY DEVICES, LTD., Sagamihara-shi, Kanagawa (JP)

(21) Appl. No.: 13/392,275

(22) PCT Filed: Sep. 2, 2010
(86) PCT No.: PCT/JP2010/065012

§ 371 Date: Feb. 24, 2012

(30) Foreign Application Priority Data
Sep. 2, 2009 (JP) 2009-202144

(51) Int. Cl. H01M 2/00

(52) U.S. Cl. 429/7

(57) ABSTRACT

Provided is an assembled battery module in which a plurality of laminated cells can be assembled within a short time. An assembled battery module comprising: a plurality of laminated cells 1 being stacked on each other, each of the plurality of laminated cells 1 including positive electrode terminal 1a and negative electrode terminal 1b, positive electrode terminal 1a and negative electrode terminal 1b being pulled out in the same direction; terminal fixing plate 3 disposed on a side of the plurality of laminated cells 1 to which positive electrode terminals 1a and negative electrode terminals 1b are pulled out; and terminal connection board 2 disposed between the plurality of laminated cells 1 and terminal fixing plate 3 and secured to terminal fixing plate 3, terminal connection board 2 including a plurality of terminal through-holes 2a each receiving positive electrode terminal 1a or the negative electrode terminal 1b. Positive electrode terminal 1a and negative electrode terminal 1b are inserted into terminal through-holes 2a, and sandwiched between terminal connection board 2 and terminal fixing plate 3 with parts that protrude from terminal through-holes 2a being vertically folded.

### TECHNICAL FIELD

The present invention relates to an assembled battery module configured by stacking a plurality of laminated cells.

### BACKGROUND ART

In recent years, at a portable terminal represented by a mobile phone or a notebook computer, cases requiring use of light-weight and high-capacity cells have increased. This has led to employment of a laminated cell that contains battery elements, such as electrodes and electrolytes, and is hermetically sealed by a laminated film having a relatively high design flexibility.

The laminated cell is suitably used when a plurality of laminated cells are stacked to form a multi-serial battery pack or battery module. Cases of using such battery packs or battery modules in devices such as a power-assisted bicycle, a power tool, and an electric car that requires high current have increased.

As a method for connecting the plurality of laminated cells in series or in parallel, resistance welding, ultrasonic welding, or laser welding is used. Each of these connecting methods is known as a conventional technology.

Patent Literature 1 describes a battery block (battery module) that includes a plurality of cells each having a positive electrode terminal and a negative electrode terminal that protrude in the same direction, and a connection lead plate for interconnecting the terminals of the cells. In the battery module described in Patent Literature 1, the plurality of cells are arrayed in a direction orthogonal to the protruding direction of terminals, and the terminals of the cells are accordingly arranged in parallel with each other. The connection lead plate for interconnecting the terminals arranged in parallel with each other is linearly disposed in the direction orthogonal to the protruding direction of the terminals, and electrically connected to each terminal by spot welding.

Patent Literature 2 describes a battery connection structure and a battery connection method for easily and surely interconnecting opposing terminals between electric cells adjacent to each other. According to such a structure or method for connecting the electric cells, a battery module can be formed by arranging the electric cells such that polarities of the adjacent terminals are different from each other and by binding them. This battery module is covered with a terminal connection board made of an insulating material, and each terminal of the electric cell of the battery module protrudes from each terminal insertion hole of the terminal connection board. Parts of the terminals to be interconnected that protrude from the terminal insertion holes of the terminal connection board are folded to be ultrasonically bonded. The terminals are accordingly connected in series.

### CITATION LIST

### Patent Literature

Patent Literature 1: JP2002-117828A
Patent Literature 2: JP2004-327311A

### SUMMARY OF INVENTION

However, in the abovementioned configurations, there is a possibility that when the number of stacked cells increases to form a multi-serial and multi-parallel battery module, there will be an increase in the amount of insulating materials and in the number of places to be welded, thus extending the assembly time.

It is an object of the present invention to provide an assembled battery module in which a plurality of laminated cells can be assembled within a short time.

### SOLUTION TO PROBLEMS

To achieve the object, an assembled battery module according to the present invention comprises: a plurality of laminated cells being stacked on each other, each of the plurality of laminated cells including a positive electrode terminal and a negative electrode terminal, the positive electrode terminal and the negative electrode terminal being pulled out in the same direction;

a terminal fixing plate disposed on a side of the plurality of laminated cells to which the positive electrode terminals and the negative electrode terminals are pulled out; and

a terminal connection board disposed between the plurality of laminated cells and the terminal fixing plate and secured to the terminal fixing plate, the terminal connection board including a plurality of terminal through-holes each receiving the positive electrode terminal or the negative electrode terminal. The positive electrode terminal and the negative electrode terminal are inserted into the terminal through-holes, and sandwiched between the terminal connection board and the terminal fixing plate with parts that protrude from the terminal through-holes being vertically folded.

### EFFECTS OF INVENTION

The present invention can provide an assembled battery module in which a plurality of laminated cells can be assembled within a short time.

### BRIEF DESCRIPTION OF DRAWINGS

FIG. 1 A perspective view showing a terminal connection board of an assembled battery module according to the present invention.

FIG. 2 An exploded perspective view showing the assembled battery module according to the present invention.

FIG. 3 A perspective view showing a terminal fixing plate of the assembled battery module according to the present invention.

FIG. 4A A plan view showing the terminal fixing plate shown in FIG. 3.

FIG. 4B A front view showing the terminal fixing plate shown in FIG. 3.

FIG. 4C A side view showing the terminal fixing plate shown in FIG. 3.

FIG. 5 A perspective view showing an assembled battery module according to Example 2 of the present invention.

FIG. 6 An exploded perspective view showing the assembled battery module according to Example 2 of the present invention.

### DESCRIPTION OF EMBODIMENTS

Embodiments of the present invention are described in detail.

An assembled battery module according to the present invention is assembled as a module by connecting a plurality of laminated cells to a terminal connection board. Terminals of the laminated cells are electrically interconnected not by processing such as welding or soldering but by sandwiching positive electrode terminals and negative electrode terminals of the laminated cells between the terminal connection board and a terminal fixing plate. This enables assembling of the laminated cells within a time shorter than that of a connection method based on the processing.

In the sandwiching method of the positive electrode terminals and the negative electrode terminals of the laminated cells used in the present invention, each of the positive electrode and negative electrode terminals is not individually and directly sandwiched, but the positive electrode terminals and the negative electrode terminals are sandwiched together by fastening the terminal fixing plate to the terminal connection board. This sandwiching method enables assembling of the plurality of laminated cells into a module within a time shorter than that of individually sandwiching each of the positive electrode and negative electrode terminals.

The positive electrode terminals and the negative electrode terminals of the laminated cells are sandwiched and supported between the terminal connection board and the terminal fixing plate. Accordingly, the assembled battery module can be easily disassembled. When certain laminated cells are defective, only the defective laminated cells need to be replaced. The other good laminated cells can be used as they are. The assembled battery module of the present invention has high recyclability because of this structure.

According to the present invention, the assembled battery module can be manufactured by inserting the positive electrode terminals and the negative electrode terminals of the laminated cells into terminal through-holes of the terminal connection board, vertically folding the positive electrode terminals and the negative electrode terminals that protrude from the board, and depressing the positive electrode terminals and the negative electrode terminals by output terminal depressing ribs of the terminal fixing plate to bring them into contact with conductive parts of the terminal connection board.

By inserting output terminal disconnection prevention ribs of the terminal fixing plate into the through-holes of the output terminals (positive electrode terminals and negative electrode terminals), disconnection of the output terminals is prevented.

A circuit from the positive electrode terminals to the negative electrode terminals of the stacked laminated cells is arranged on the terminal connection board having the terminal through-holes, thereby enabling serial connection of the laminated cells via the terminal connection board. Some arrangements of the circuit enable parallel connection.

The terminal fixing plate and the terminal connection board are fastened together by the output terminal disconnection prevention ribs arranged in the terminal fixing plate. Screws are also used to assure the fixing.

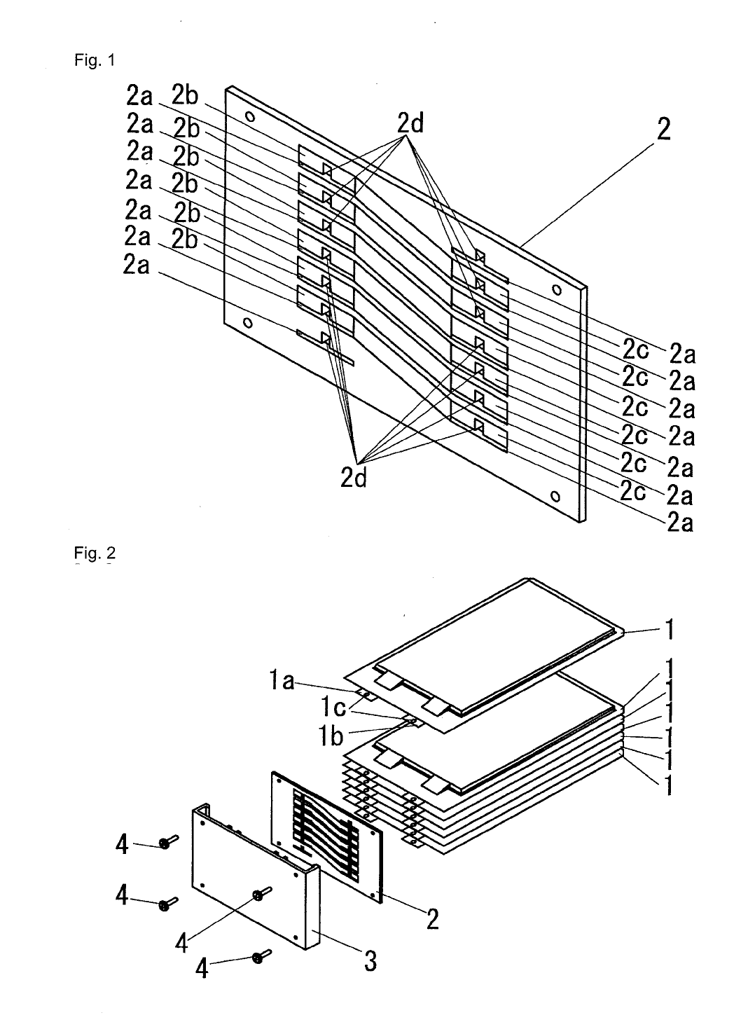

FIG. 1 is a perspective view showing the terminal connection board of the assembled battery module according to the present invention.

Terminal connection board 2 includes terminal through-holes 2a, disconnection prevention rib through-holes 2d, and conductive parts 2b and 2c, and conductive part 2b and conductive part 2c are interconnected by a circuit. According to the shown embodiment, laminated cells can be connected in series via terminal connection board 2. Such a circuit is only an example. Other embodiments can deal with various forms such as parallel connection and series-parallel connection.

FIG. 2 is an exploded perspective view showing the assembled battery module according to the present invention.

Positive electrode terminals 1a and negative electrode terminals 1b of laminated cells 1 each having through-hole 1c are inserted into the terminal through-holes of terminal connection board 2, and positive electrode terminals 1a and negative electrode terminals 1b that protrude are folded vertically upward. Positive electrode terminals 1a and negative electrode terminals 1b accordingly come into contact with the conductive parts of terminal connection board 2.

Then, output terminal disconnection prevention ribs of terminal fixing plate 3 are inserted into through-holes 1c of laminated cells 1 and the disconnection prevention rib through-holes of terminal connection board 2. Four corners of terminal connection board 2 and terminal fixing plate 3 are fastened by screws 4, thereby sandwiching positive electrode terminals 1a and negative electrode terminals 1b between the conductive parts of terminal connection board 2 and the output terminal depressing ribs of terminal fixing plate 3. Thus, positive electrode terminals 1a and negative electrode terminals 1b are electrically interconnected to manufacture an assembled battery module.

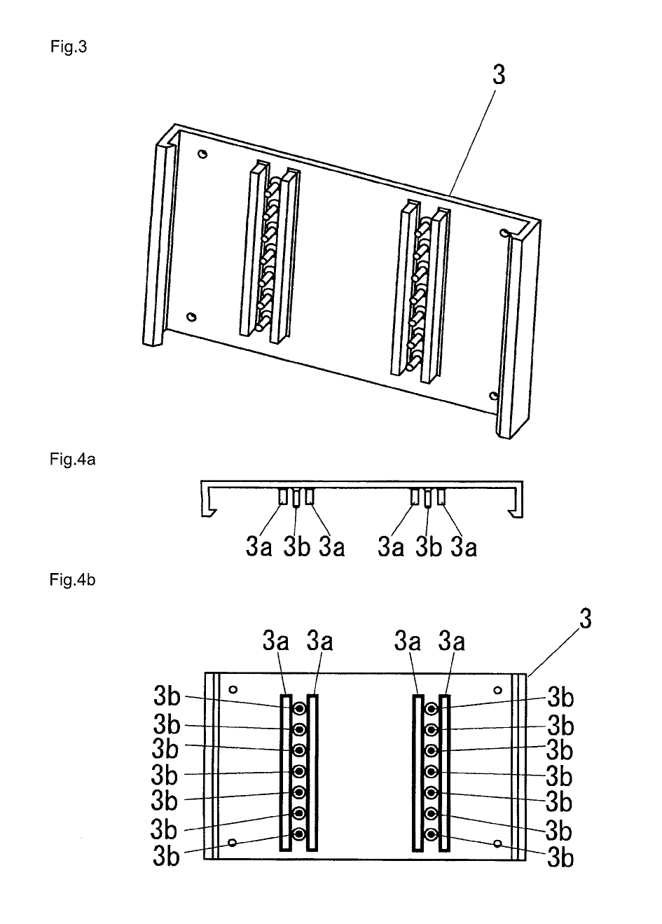

FIG. 3 is a perspective view showing the terminal fixing plate of the assembled battery module according to the present invention.

Terminal fixing plate 3 is a member for fixing the terminals. For a material for terminal fixing plate 3, therefore, an insulator having strength is preferably used. More preferably, a resin suited to molding, such as general-purpose plastic including an acrylonitrile butadiene styrene (ABS) resin or an engineering plastic including a polycarbonate (PC), is used.

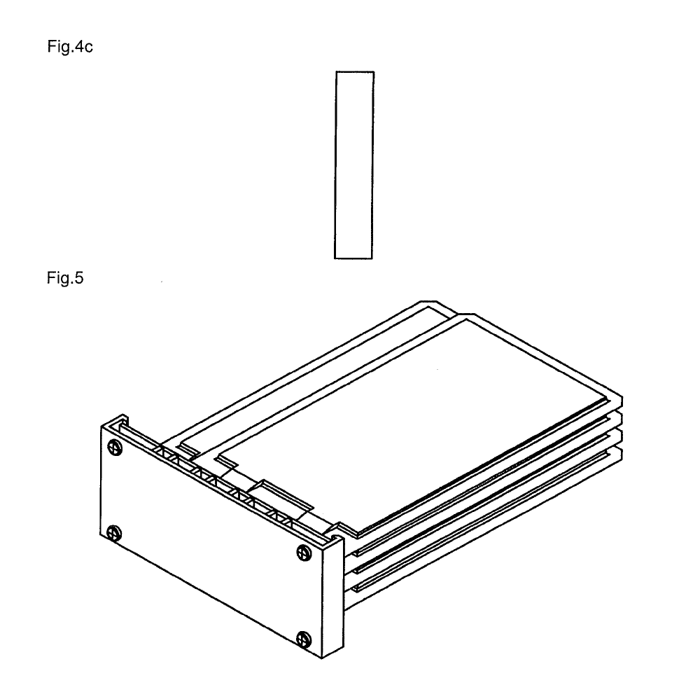

FIGS. 4A to 4C show three surfaces of the terminal fixing plate of the assembled battery module according to the present invention: FIG. 4A being a plan view, FIG. 4B being a front view, and FIG. 4C being a side view.

Terminal fixing plate 3 includes output terminal depressing ribs 3a and output terminal disconnection prevention ribs 3b. Output terminal depressing ribs 3a electrically interconnects the positive electrode terminals and the negative electrode terminals by pressing the conductive parts of the terminal connection board to sandwich the positive electrode terminals and the negative electrode terminals between the output terminal depressing ribs and the conductive parts. Disconnection of the positive electrode terminals and the negative electrode terminals of the laminated cells is prevented by inserting output terminal disconnection prevention ribs 3b into the through-holes of the laminated cells and the disconnection prevention rib through-holes of the terminal connection board.

According to the shown embodiment, disconnection of the positive electrode terminals and the negative electrode terminals is prevented by setting output terminal disconnection prevention ribs 3b higher than output terminal depressing ribs 3a. Disconnection can also be prevented by making the leading end of output terminal disconnection prevention rib 3b thick, thereby reducing the clearance from the through-hole of the laminated cell.

Output terminal depressing ribs 3a are preferably set to have an equal height so that the individual positive electrode and negative electrode terminals are sandwiched by a uniform force.

In the assembled battery module according to the present invention, the positive electrode terminals and the negative electrode terminals of the laminated cells are inserted into the terminal through-holes of the terminal connection board, and vertically folded upward to come into contact with the conductive parts of the terminal connection board, thereby achieving electric connection between the output terminals. The output terminal disconnection prevention ribs prevent disconnection of the positive electrode terminals and the negative electrode terminals, and by using the screws to fix the terminal connection board and the terminal fixing plate the electric connection is assured. As a result, the assembled battery module can be assembled within a short time without any need to individually fasten the positive electrode terminal and the negative electrode terminal to each of the conductive parts of the terminal connection board.

### EXAMPLES

Hereinafter, the present invention is described in detail referring to specific Examples.

### Example 1

In the present Example, as shown in FIG. 2, seven laminated cells each having a positive electrode terminal and a negative electrode terminal formed in the same direction are stacked to be connected to a terminal connection board.

The used laminated cell has a thickness of 6 millimeters. Each of the positive electrode and negative electrode terminal pulled out of a laminated film, which has a terminal width of 13 millimeters, a terminal length of 3 millimeters, and a terminal thickness of 0.15 millimeters, includes a through-hole having a diameter of 2 millimeters.

All the positive electrode and negative electrode terminals were inserted into terminal through-holes of the terminal connection board, and vertically folded upward. Output terminal disconnection prevention ribs of a terminal fixing plate were inserted into through-holes of the positive electrode and negative electrode terminals and the disconnection prevention rib through-holes of the terminal connection board, and the terminal fixing plate and the terminal connection board were fastened together by four screws to manufacture an assembled battery module.

Ten sets of such assembled battery modules were manufactured, and the assembly time was measured. The assembly time for one set was 100.6 seconds on average.

### Example 2

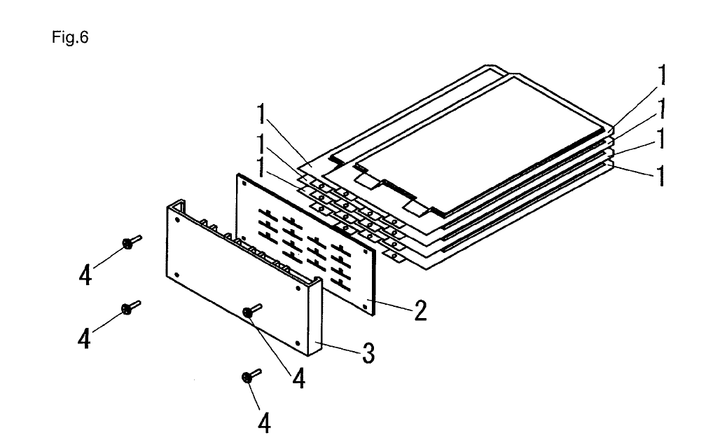

FIG. 5 is a perspective view showing an assembled battery module according to Example 2 of the present invention. FIG. 6 is an exploded perspective view showing the assembled battery module according to Example 2 of the present invention.

According to the present Example, terminal through-holes and conductive parts are formed on a board to lower its height. As shown in FIG. 6, seven laminated cells each having a positive electrode terminal and a negative electrode terminal formed in the same direction are stacked to be connected to a terminal connection board.

In FIG. 1, each of the terminal through-holes and the conductive parts of the terminal connection board has a height of 8 millimeters and a length of 14 millimeters. In FIG. 6, however, the height is 5 millimeters, and the length is 14 millimeters. As the height of the board is lowered, terminal through-holes and conductive parts of such sizes are arranged by being positionally shifted not to overlap each other. Specifically, first, to prevent the terminal through-holes and the conductive parts to which a laminated cell first from above is connected from overlapping with that to which a second laminated cell is connected, a position of the second laminated cell was shifted to the left by 15 millimeters and to the upper side by 3 millimeters from the position shown in FIG. 2.

A third laminated cell was located 6 millimeters directly below the first laminated cell by shifting positions of the terminal through-holes and the conductive parts. Fifth and seventh laminated cells were similarly located. The positions of the terminal through-holes and the conductive parts were shifted to locate a fourth laminated cell 6 millimeters directly below the second laminated cell and a sixth laminated cell 6 millimeters directly below the fourth laminated cell. In the present Example, laminated cells similar to those of the Example 1 were used.

All the positive electrode and negative electrode terminals were inserted into the terminal through-holes of the terminal connection board, and vertically folded upward. Output terminal disconnection prevention ribs of a terminal fixing plate were inserted into through-holes of the positive electrode and negative electrode terminals and the disconnection prevention rib through-holes of the terminal connection board, and the terminal fixing plate and the terminal connection board were fastened together by four screws to manufacture an assembled battery module.

Ten sets of such assembled battery modules were manufactured, and the assembly time was measured. The assembly time for one set was 90.9 seconds on average.

### Example 3

An assembled battery module was manufactured similarly to Example 2 except for the following: a plurality of laminated cells were fastened and integrated together by tapes, and thereafter connected to a terminal connection board.

Ten sets of such assembled battery modules were manufactured, and the assembly time was measured. The assembly time for one set was 89.2 seconds on average.

Means for fastening and integrating the laminated cells according to the present Example is not limited to the tapes. Any means can be used as long as the plurality of laminated cells can be fastened together, and double-faced tapes, resins, or adhesives can be used.

### Comparative Example

By using laminated cells and a terminal connection board similar to those of Example 1, all positive electrode and negative electrode terminals were inserted into terminal through-holes of the terminal connection board, and vertically folded upward.

Without using any terminal fixing plate, all the positive electrode and negative electrode terminals were soldered to conductive parts to manufacture an assembled battery module.

Ten sets of such assembled battery modules were manufactured, and the assembly time was measured. The assembly time for one set was 122.6 seconds on average.

Table 1 shows average assembly time and standard deviation when the seven laminated cells were stacked to manufacture the assembled battery module in each of Examples 1 to 3 and the Comparative Example.

TABLE 1

| | average assembly time | standard deviation |
|---|---|---|
| | (second/set) | (second/set) |
| Example 1 | 100.6 | 3.75 |
| Example 2 | 90.9 | 3.18 |
| Example 3 | 89.2 | 5.09 |
| Comparative | 122.6 | 8.28 |
| Example | | |

Table 1 confirms that the assembly time of the assembled battery modules is shorter in Examples 1 to 3 than that of the Comparative Example.

The assembly time is shorter, and its variance (standard deviation) is larger in Example 3 than those in Examples 1 and 2. A reason can be as follows: in Example 3, the laminated cells were fastened and integrated together, and thus the positive electrode and negative electrode terminals can be inserted into the terminal through-holes of the terminal connection board at once, thereby enabling assembly within a short time.

On the other hand, in Example 3, when insertion of any one of the positive electrode and negative electrode terminals into the terminal through-hole fails, adjustment must be made to insert the terminal. This may cause a larger variance than those of Examples 1 and 2.

Variances on assembly time in Examples 1 to 3 are smaller than that of the Comparative Example. A reason can be as follows: in the Examples, variances in the amount of time for inserting the output terminal disconnection prevention ribs of the terminal fixing plate into the positive electrode and negative electrode terminals and the disconnection prevention rib through-holes of the terminal connection board are smaller than those in the amount of time for temporarily arranging and soldering the positive electrode and negative electrode terminals to the conductive parts of the terminal connection board. This result shows that operations in Examples 1 to 3 can be carried out more accurately than in the Comparative Example.

Thus, it has been confirmed that the present invention can provide an assembled battery module in which a plurality of laminated cells can be assembled within a short time.

While the present invention has been particularly shown and described with reference to the embodiment and the Examples, the present invention is not limited to the embodiment and the Examples described above. It will be understood by those skilled in the art that various changes in form and details may be made therein without departing from the scope of the present invention as defined by the claims.

This application is based upon and claims the benefit of priority from Japanese Patent Application No. 2009-202144 filed on Sep. 2, 2009, the disclosure of which is incorporated herein in its entirety by reference.

### EXPLANATION OF REFERENCE NUMERALS

1 Laminated cell
1a Positive electrode terminal
1b Negative electrode terminal
1c Through-hole
2 Terminal connection board
2a Terminal through-hole
2b Conductive part
2c Conductive part
2d Disconnection prevention rib through-hole
3 Terminal board fixing plate
3a Output terminal depressing rib
3b Output terminal disconnection prevention rib
4 Screw

1-3. (canceled)

4. An assembled battery module comprising:
a plurality of laminated cells being stacked on each other, each of the plurality of laminated cells including a positive electrode terminal and a negative electrode terminal, the positive electrode terminal and the negative electrode terminal being pulled out in the same direction; and
a terminal connection board including a plurality of terminal through-holes each receiving the positive electrode terminal or the negative electrode terminal, and a circuit electrically connected to the positive electrode terminal or the negative electrode terminal, or to the positive electrode terminal and the negative electrode terminal,
wherein the positive electrode terminal and the negative electrode terminal are inserted into the terminal through-holes to be electrically connected to the terminal connection board.

5. The assembled battery module according to claim 4, wherein the positive electrode terminal and the negative electrode terminal are sandwiched between the terminal connection board and a terminal fixing plate to be electrically connected to the terminal connection board.

6. The assembled battery module according to claim 5, wherein parts of the positive electrode terminal and the negative electrode terminal that protrude from the terminal through-holes are sandwiched between conductive parts of the terminal connection board and output terminal depressing ribs of the terminal fixing plate.

7. The assembled battery module according to claim 5, wherein the terminal fixing plate includes a plurality of output terminal disconnection prevention ribs, and the terminal connection board includes a plurality of disconnection prevention rib through-holes corresponding to the output terminal disconnection prevention ribs,
wherein through-holes are respectively formed in the parts of the positive electrode terminal and the negative electrode terminal that protrude from the terminal through-holes, and
wherein the output terminal disconnection prevention ribs are inserted into the through-holes of the positive electrode terminal or the negative electrode terminal and the disconnection prevention rib through-holes.
